(19) United States
(12) Patent Application Publication
(10) Pub. No.: US 2026/0212767 A1
(43) Pub. Date: Jul. 23, 2026

(54) SYSTEM AND METHOD FOR IDENTIFYING OBSTACLES IN RELATION TO AN AIRCRAFT

(71) Applicant: THE BOEING COMPANY, Arlington, VA (US)

(72) Inventors: Kennedy Nwankwo, Lutherstr 66 Hessen (DE); Igor Petrouchenkov, Dubai (AE); Vinko Vidakovic, Frankfurt am Main Hessen (DE); Zied Hamdi, Kelesterbach Hessen (DE)

(73) Assignee: THE BOEING COMPANY, Arlington, VA (US)

(21) Appl. No.: 19/033,837

(22) Filed: Jan. 22, 2025

(51) Int. Cl. G08G 5/59; G08G 5/23

(52) U.S. Cl. CPC G08G 5/59; G08G 5/23

(57) ABSTRACT

An aircraft is configured to travel between a departure airport and an arrival airport. A control unit is in communication with a user interface. The control unit is configured to: (a) receive a first dataset and a second dataset, wherein the first dataset includes first data in a first format, wherein the second dataset includes second data in a second format, and wherein each of the first dataset and the second dataset includes information regarding obstacles, (b) compare the first dataset with the second dataset to determine a quality check of the information within the first dataset and the second dataset, and (c) output one or more signals to the user interface regarding the obstacles and the quality check. The aircraft is configured to be operated in relation to the obstacles.

### FIELD OF THE DISCLOSURE

Examples of the present disclosure generally relate to systems and methods for identifying obstacles in relation to an aircraft.

### BACKGROUND OF THE DISCLOSURE

Aircraft are used to transport passengers and cargo between various locations. Numerous aircraft depart from and arrive at a typical airport every day.

Various obstacles exist at and between the different airports. Obstacles can be natural, such as mountains, hills, forests, and the like, and manmade, such as buildings, bridges, cellphone towers, and the like. As another example, obstacles can be fixed vehicle routes, such as railroads. The aircraft is operated in relation to the obstacles, such as around, away from, and/or above the obstacles.

Navigation data that is used by operators of aircraft typically includes information regarding obstacles in relation to the aircraft. The navigation data can be in different formats, such as an aeronautical information exchange model (AIXM), keyhole markup language (KML), Excel, comma-separated values (CSV), and/or the like. Obstacle information in each of the different formats may not always be consistent. For example, obstacle information in one of the formats may differ from obstacle information in a different format.

A third party may analyze the information in the different formats to determine the location of the obstacles. However, the comparison can be time and labor intensive due to data inconsistencies between the different formats, resolution, and in some cases varying spatial and temporary differences. Thus, information regarding obstacles from the different formats can be duplicative or even omitted.

A known method utilizes a feature manipulation engine (FME), and other data analytics tools to carry out a 1-to-1 comparison of obstacle data within the different data formats. However, the different data formats can be substantially different, and a 1-to-1 comparison without any commonality therebetween can increase time and labor, and also be susceptible to errors and inaccuracies.

### SUMMARY OF THE DISCLOSURE

A need exists for a system and a method for determining a quality check between obstacle data in different formats. With that need in mind, examples of the present disclosure provide a system including a control unit configured to receive a first dataset and a second dataset. The first dataset includes first data in a first format. The second dataset includes second data in a second format. Each of the first dataset and the second dataset includes information regarding obstacles. The control unit is further configured to compare the first dataset with the second dataset to determine a quality check of the information within the first dataset and the second dataset.

One or both of the control unit or the user interface can be remote from an aircraft. Alternatively, an aircraft can include one or both of the control unit or the user interface.

In at least one example, the control unit is configured to receive the first dataset and the second dataset from one or more air navigation service providers.

In at least one example, the control unit is further configured to geospatially index the first data and the second data.

In at least one example, the control unit is further configured to determine boundaries within the first data and the second data from classifications set forth by the International Civil Aviation Organization (ICAO). As a further example, the control unit is further configured to determine ICAO Area 1, ICAO Area 2, ICAO Area 2a, ICAO Area 2b, ICAO Area 2c, ICAO Area 2d, and ICAO Area 3, ICAO Area 4 within the first data and the second data. As a further example, the control unit is further configured to determine one or more combined areas including two or more of ICAO Area 1, ICAO Area 2, ICAO Area 2a, ICAO Area 2b, ICAO Area 2c, ICAO Area 2d, and ICAO Area 3, ICAO Area 4.

In at least one example, the control unit is further configured to generate a dynamic grid.

The control unit can be configured to determine the quality check based on comparing elevation, latitude, longitude, obstacle type, and source identifier for the obstacles within the first dataset and the second dataset.

The control unit can be further configured to check that each of the first dataset and the second dataset are in correct formats for a particular country.

In at least one example, the system can further include an aircraft configured to travel between a departure airport and an arrival airport according to a flight path, and a user interface. The control unit is further configured to output one or more signals regarding the obstacles and the quality check. The user interface is configured to receive the one or more signals regarding the obstacles and the quality check. The aircraft is configured to be operated in relation to the obstacles.

Certain examples of the present disclosure provide a method including receiving, by a control unit, a first dataset and a second dataset, wherein the first dataset includes first data in a first format, wherein the second dataset includes second data in a second format, and wherein each of the first dataset and the second dataset includes information regarding obstacles; comparing, by the control unit, the first dataset with the second dataset; and determining, by the control unit via said comparing, a quality check of the information within the first dataset and the second dataset.

### BRIEF DESCRIPTION OF THE DRAWINGS

FIG. 1 illustrates a schematic block diagram of a system, according to an example of the present disclosure.

FIG. 2 illustrates a simplified view of boundaries in relation to an airport, according to an example of the present disclosure.

FIG. 3 illustrates a flow chart of a method, according to an example of the present disclosure.

FIG. 4 illustrates a front view of a display showing a grid, according to an example of the present disclosure.

FIG. 5 illustrates a schematic block diagram of a control unit, according to an example of the present disclosure.

FIG. 6 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

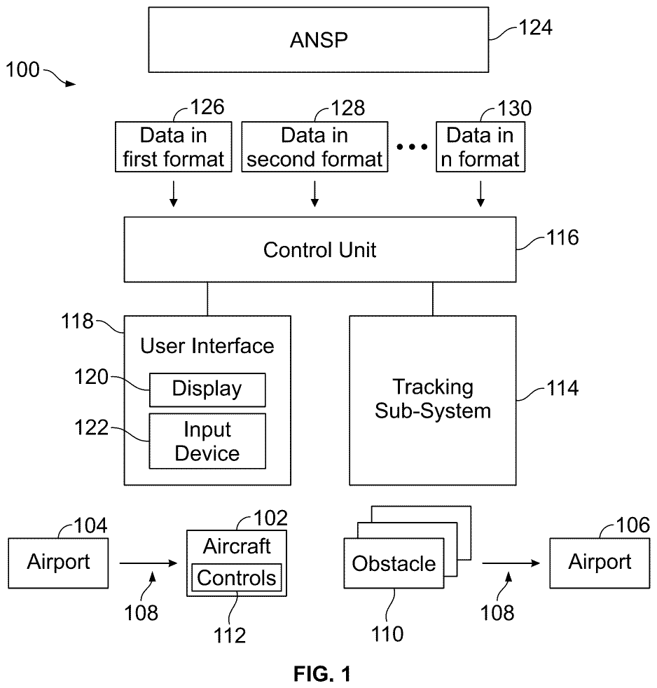

FIG. 1 illustrates a schematic block diagram of a system 100, according to an example of the present disclosure. An aircraft 102 is operated to fly from a departure airport 104 to an arrival airport 106, such as along a flight path 108. Numerous obstacles 110 are located between the departure airport 104 and the arrival airport 106. The obstacles 110 can be natural (such as mountains, hills, forests, and the like), manmade, (such as buildings, bridges, cellphone towers, and the like), fixed vehicle routes (such as railroads, defined water routes, and/or the like). The obstacles 110 are in relation to one or more portions of the flight path 108. For example, the obstacles 110 can be within the flight path 108, proximate to the flight path 108 (such as within 5 miles or less), distally located from the flight path 108 (such as 5 miles or more away from the flight path 108), or the like. The aircraft 102 is operated to fly according to the flight path 108, and in relation to the obstacles 110 (such as around, away from, above, and/or the like the obstacles 110). The aircraft 102 can be operated to fly at altitudes along the flight path 108 in which various obstacles 110 are not an issue. For example, at cruising altitudes, various obstacles 110 are well below the aircraft 102. However, at certain portions of the flight path 108 (such as during takeoff or landing), certain obstacles 110 are to be avoided.

The aircraft 102 includes controls 112 that are configured to control operation of the aircraft 102. For example, the controls 112 include one or more of a control handle, yoke, joystick, control surface controls, accelerators, decelerators, and/or the like.

A tracking sub-subsystem 114 tracks the aircraft 102 along the flight path 108 from the departure airport 104 to the arrival airport 106. The tracking sub-system 114 is configured to track the aircraft 102 on the ground and within an airspace. In at least one example, the tracking sub-system 114 is configured to track positions of the aircraft 102 in real time. In at least one example, the tracking sub-system 114 is a radar sub-system. As another example, the tracking sub-system 114 is an automatic dependent surveillance-broadcast (ADS-B) tracking sub-system. Real time positions of the aircraft 102 on the ground and within the airspace are detected by the tracking sub-system 114 that receives position signals output by a position sensor of the aircraft 102. For example, the tracking sub-system 114 receives ADS-B signals output by the position sensor(s) of the aircraft 102. As another example, the position sensor(s) of the aircraft 102 can be global positioning system sensors. The position sensor(s) outputs signals indicative of one or more of the position, altitude, heading, acceleration, velocity, and/or the like of the aircraft 102. The signals are received by the tracking sub-system 114. The control unit 116 receives the tracking information of the aircraft 102, such as from the tracking sub-system 114.

The system 100 includes a control unit 116 in communication with a user interface 118, such as through one or more wired or wireless connections. The user interface 118 includes a display 120 in communication with an input device 122. The display 120 can be a monitor, screen, television, touchscreen, and/or the like. The input device 122 can include a keyboard, mouse, stylus, touchscreen interface (that is, the input device 122 can be integral with the display 120), and/or the like. The user interface 118 can be part of a handheld device (such as a smart phone or smart tablet), a portable computer, a computer workstation, and/or the like. In at least one example, the control unit 116 and the user interface 118 are part of a common computing device.

The control unit 116 and/or the user interface 118 can be remotely located from the aircraft 102, such as at a central monitoring location. As another example, the aircraft 102 can include the user interface 118. In at least one other example, the aircraft 102 includes the control unit 116 and the user interface 118.

In at least one example, the control unit 116 is also in communication with the tracking sub-system 114, such as through one or more wired or wireless connections. The control unit 116 can be remotely located from the tracking sub-system 114. As another example, the control unit 116 can be co-located with the tracking sub-system 114.

The control unit 116 is further in communication with one or more air navigation service providers (ANSPs) 124, such as through one or more wired or wireless connections. For example, the control unit 116 receives signals from the ANSP such as through radio communication, the Internet, an electronic signal network, and/or the like. The ANSP 124 and the control unit 116 can be remotely located from one another. As another example, the ANSP 124 and the control unit 116 can be co-located.

The ANSP 124 outputs data in various formats to the control unit 116. For example, the ANSP 124 outputs a first dataset (such as data in a first format 126), a second dataset (such as data in a second format 128), . . . and an nth dataset (such as data in an n format 130). The ANSP 124 can output data in two more different formats. Each format differs from one another. Optionally, two or more of the datasets can be in the same format. Non-limiting examples of the formats include an aeronautical information exchange model (AIXM), keyhole markup language (KML), Excel, comma-separated values (CSV), and/or the like. The data in the formats is output electronically and received by the control unit 116. For example, the ANSP 124 outputs the data as electronic signals that are received by the control unit 116, such as through an antenna, a network connection, the Internet, or the like. The data in the formats includes information regarding the obstacles 110.

In response to receiving the data in the formats, the control unit 116 geospatially indexes the data in each of the formats, and uses predetermined tolerances and rules, which define acceptable boundaries and standards for comparing information regarding the obstacles within the data in the formats to determine data quality and integrity. In at least one example, the control unit 116 analyzes the data in the formats to determine obstacle area boundaries, such as defined by the International Civil Aviation Organization (ICAO). ICAO classifies boundaries into coverage areas based on how close they are to flight safety critical infrastructure (for example, runways, taxiways, ground maneuvering areas, and the like). The data in the formats (for example 126-130) typically does not include such boundaries.

Geospatial indexing is a method used to divide defined boundaries into smaller segments or grid cells, where each cell contains references to the spatial objects that fall therein, which allows for quick access to objects based on their location. Within each grid cell, occurring data is evaluated for completeness by considering certain attributes such as elevation (for example, in feet and/or meters) and coordinates, as well as meeting ICAO specified vertical accuracy requirements for obstacle data accuracy. The system described herein can utilize a multi-resolution hexagonal global grid system with hierarchical indexing. In at least one example, a cell can be one-seventh the area of a lower resolution containing cell. Each hexagon cell at a particular resolution can be uniquely identified, and the identifiers can be truncated to find a coarser-containing cell.

As described herein, the aircraft 102 is configured to travel between the departure airport 104 and the arrival airport 106, such as according to the flight path 108. The control unit 116 is in communication with the user interface 118. The control unit 116 is configured to receive the first dataset (for example, the data in the first format 126) and the second dataset (for example, the data in the second format 128). Each of the first dataset and the second dataset includes information regarding the obstacles 110, which is in relation to the flight path 108 (particularly at low altitude portions of the flight paths, such as during takeoff and landing phases). The control unit 116 is further configured to compare the first dataset with the second dataset to determine a quality check of the information within the first dataset and the second dataset. In at least one example, the control unit 116 is further configured to output one or more electronic signals (which include data) to the user interface 118 regarding the obstacles 110 and the quality check.

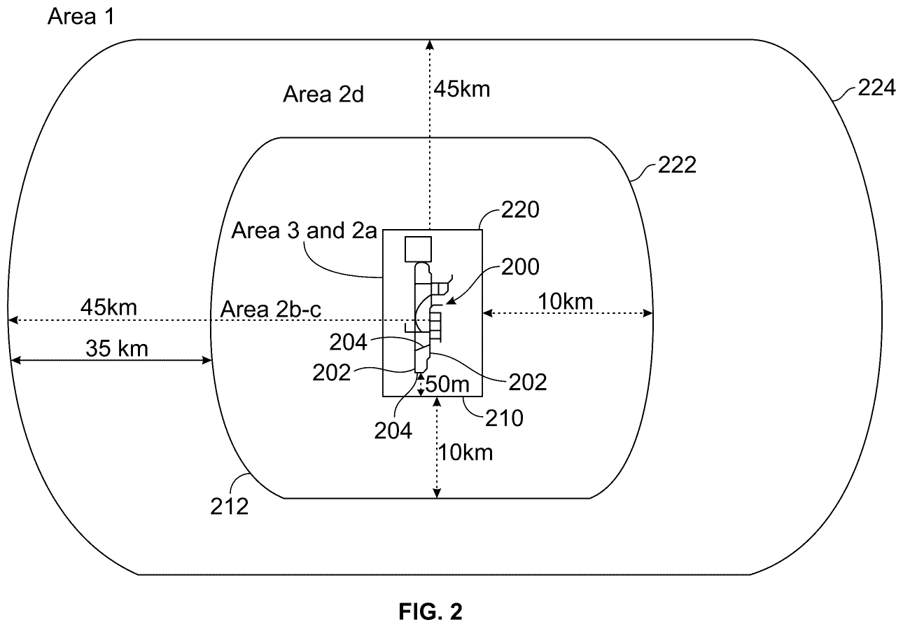

FIG. 2 illustrates a simplified view of boundaries in relation to an airport 200, according to an example of the present disclosure. The airport 200 is an example of the departure airport 104 and the arrival airport 106 shown in FIG. 1. The airport 200 includes one or more runways 202 and one or more taxiways 204. In at least one example, ICAO Area 1 (or Area 1) is an entirety of a state or country in which the airport 200 is located. ICAO Area 2 (or Area 2) is the vicinity of an aerodrome (for example, the airport 200), such as a terminal control area (or an area within a 45 kilometer (km) radius of a center of the airport 200). ICAO Area 3 (or Area 3) is an area bordering a movement area on the aerodrome. ICAO Area 4 is a 120 meter (m) ×900 m area in a direction of approach of a precision approach runway (CATII/III RWY). ICAO Area 2a (or Area 2a) is a rectangular area around a runway 202 that includes the runway strip and any clearway. ICAO Area 2b (or Area 2b) is a 10 kilometer (km) that extends from the ends of area 2a in the direction of departure. ICAO Area 2c (or Area 2c) is a defined area around an aerodrome that extends up to 10 km from the boundary of Area 2a. ICAO Area 2d (or Area 2d) is an area outside of Areas 2a, 2b, and 2c, and is up to 45 km from the aerodrome reference point. In at least one example, Area 2d is 35 km from the edge of area 2b-c

Referring to FIGS. 1 and 2, the control unit 116 receives information regarding the ICAO Areas in relation to the airport 200, such from as ICAO. In at least one example, the information regarding the ICAO areas is stored in a memory of the control unit 116. Based on the ICAO areas, the control unit 116 then determines a combined Area 210, which is Area 3 and 2a (that is, Area 3+Area 2a). In at least one example, the combined area 210 (that is, Area 3 and 2a) is 50 m from a maxima edge of taxiway and runway. Further, the control unit 116 determines a combined Area 212, which is area 2b-c. In at least one example, Area 2b-c is 10 km from the edges of area 3 and 2a.

In at least one example, the control unit 116 automatically creates boundaries 220, 222, and 224 based on the geometry of the airport, relevant infrastructure, and ICAO obstacle area parameters. As shown, the control unit 116 determines boundary 220 as the combined area 210. Further, the control unit 116 determines boundary 222 as the combined area 212. Further, the control unit 116 determines the boundary 224 as area 2d.

In at least one example, the control unit 116 generates a dynamic grid, such as via geospatial indexing. In particular, the control unit 116 applies a dynamic grid on the various ICAO boundaries, as defined above. The generated grid automatically scales individual grid cells based on their proximity to flight critical infrastructure and thus increases granularity and accuracy for inspection. In at least one example, a dynamic grid adjusts to a created boundary.

In at least one example, the control unit 116 receives the data in the first format 126 and the data in the second format 128 from the ANSP 124. The control unit 116 then utilizes the ICAO boundaries, as set forth above, in relation to the data in the first format 126 and the data in the second format 128. The ICAO boundaries define the acceptable range of limits within which obstacle data values can vary without being considered invalid or incorrect, and serve as the basis for executing a quality check in relation to the data in the first format 126 and the data in the second format 128.

In at least one example, the control unit 116 focuses on five obstacle attributes. Because obstacle 110 in a dataset (such as the data in the first format 126 and the data in the second format 128) has over fifty attributes used for characterization, in order to perform a quality check, the control unit 116 focuses on alignment of the certain attributes. In particular, for obstacles within each of the data in the first format 126 and the data in the second format 128, the control unit 116 compares elevation (either in feet or meters), latitude, longitude, obstacle type, and source identifier. By comparing these five attributes for common obstacles within each of the different data formats (for example, an obstacle within a first dataset that corresponds to a similar obstacle within a second dataset), the control unit 116 can detect conformance or inconsistencies therewith. For example, if any of the attributes differ between the different data formats, the control unit 116 determines an inconsistency in obstacle determination, and can output a signal to the user interface 118 indicating such inconsistency, which can be shown on the display 120. Conversely, if the attributes are consistent between the different data formats, the control unit 116 confirms that location and features of the obstacle.

In operation, the control unit 116 first receives a first dataset in a first format (for example, the data in the first format 126) and the second dataset in a second format (for example, the data in the second format 128), which may differ from the first format. The first dataset and the second dataset each include information regarding the obstacles 110. The control unit 116 compares and analyzes the first dataset and the second dataset set to determine a quality of the information regarding the obstacles 110 within the two different datasets.

In particular, the control unit 116 can first check to confirm that each of the first dataset and second dataset are in the correct formats for Area 1 (such as a particular country). Information regarding the correct format is stored in a memory of the control unit 116, for example. If the datasets are not in the correct format, the control unit 116 outputs an error signal, which is shown on the display 120, and indicates that one or both of the datasets is not in the correct format.

If, however, datasets are in the correct format, the control unit 116 then performs boundary and geospatial indexing of the datasets to generate a dynamic grid. In at least on example, the control unit 116 automatically determines a boundary of an obstacle within the datasets with reference to the movement areas of the airport 200, and an aerodrome reference point, within which default parameters are used for the generation of grids that divide the obstacle data into different segments based on the generated ICAO obstacle areas. Such division enables easier and more efficient comparison between these datasets. By establishing these parameters, the control unit 116 organizes the obstacle data into manageable sections, allowing for a more granular analysis and identification of variations across different ICAO defined Obstacle areas.

Next, the control unit 116 compares the datasets and visualizes results of the comparison. In this stage, the two datasets (for example, the data in the first format 126 and the data in the second format 128) are compared based on cruciality and comparison of the two obstacles (within the datasets) with the highest elevation from both dataset within each grid cell. The control unit 116 can then show the comparison results on a grid-by-grid basis using different color schemes, thereby presenting the findings in a clear and easily understandable format, thereby allowing individuals to efficiently and effectively analyze and interpret the data.

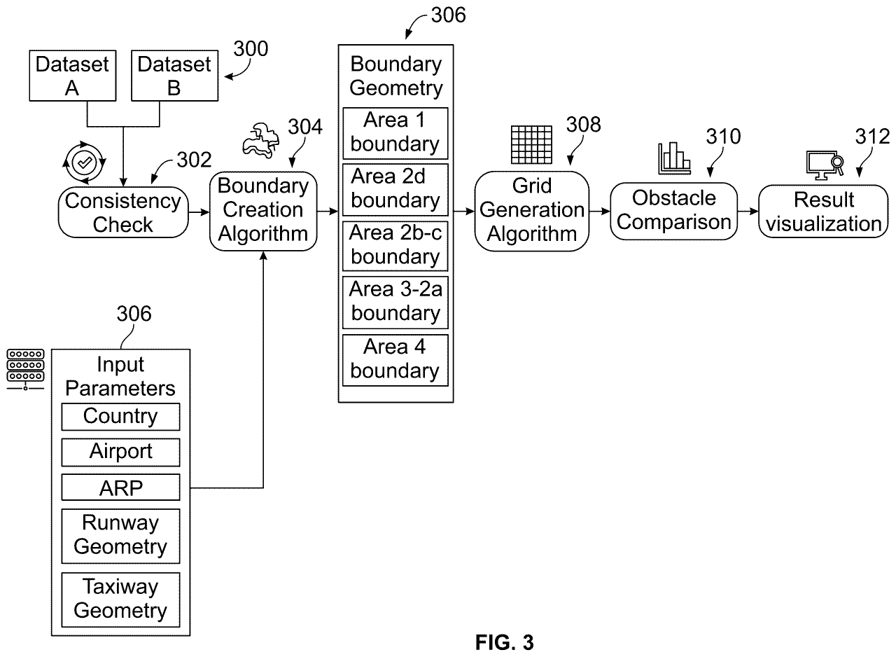

FIG. 3 illustrates a flow chart of a method, according to an example of the present disclosure. Referring to FIGS. 1-3, at 300, the control unit 116 receives dataset A (such as the data in the first format 126), and dataset B (such as the data in the second format 128).

Next, at 302, the control unit 302 checks consistency of the dataset A and the dataset B. For example, the control unit 302 confirms that each of the datasets A and B are in the correct formats for Area 1 (such as a particular country). If the datasets are not in the correct format, the control unit 116 outputs an error signal, which is shown on the display 120, and indicates that one or both of the datasets is not in the correct format.

After determining that the datasets A and B are consistent, the control unit 116 operates according to a boundary creation algorithm at 304. The control unit 116 creates the boundaries, as described herein, based on input parameters 306, such as country, airport, runway geometry, and taxiway geometry.

As an example, boundary creation refers to the creation of defined limits or edges that delineate geographic areas or features of the obstacle data being compared. A boundary creation algorithm divides the area of focus into sectors based on ICAO defined obstacle area classification. These Obstacle Areas are defined in proximity of an airport/heliport (runways+taxiways), except Area 1 which is the rest of the territory of the country. The algorithm receives input parameters such as country, airports, airport reference point (ARP), taxiway geometry and runway geometry to automatically create these boundaries. Examples of the areas are as follows: Area 4: a 120×900 m rectangle in the direction of approach of a precision approach runway (CATII/III RWY); Area 3 and 2a:50 m from the maxima edge of taxiway and runway; Area 2b-c: a stadium shape 10 km from the edges of area 3 and 2a; Area 2d: a stadium shape 35 km from the edge of area 2b-c; and Area 1: the rest of the country.

At 306, the control unit 116 determines boundary geometries, such as based on ICAO classifications. For example, the control unit 116 determines the boundary of Area 1, the boundary of Area 2d, the boundary of area 2b-c, the boundary of area 3-2a, and the boundary of Area 4.

Based on the boundaries as determined in 306, the control unit 116 then generates one or more grids within the different areas. Next at 308, the control unit 116 compares obstacles 110 within the different datasets A and B to determine if they are consistent with one another. At 312, the control unit 116 can then output signals that show the results of the comparison, the grids, and the like, on the display 120.

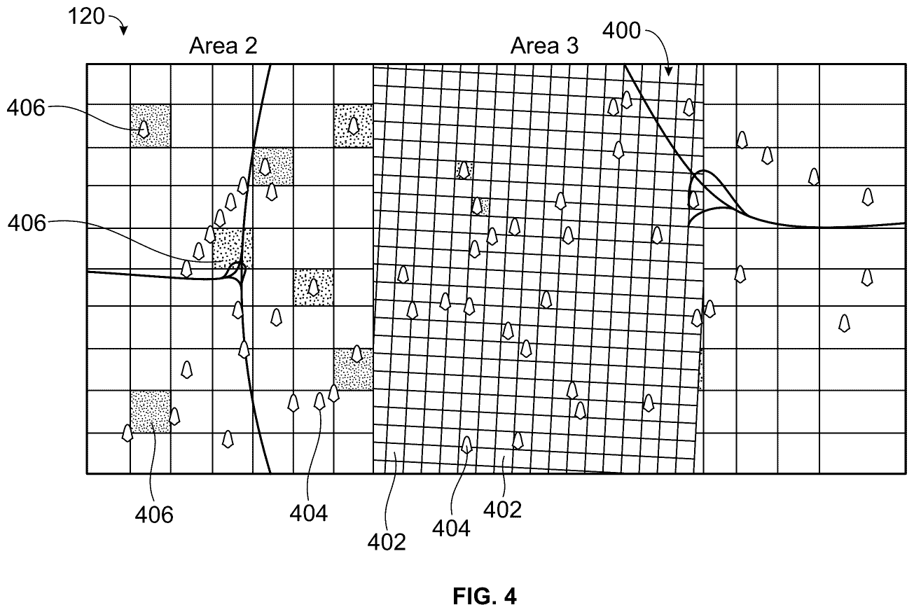

FIG. 4 illustrates a front view of the display showing a grid 400, according to an example of the present disclosure. Referring to FIGS. 1-4, the control unit 116 generates the grid 400, as described herein. A user can select various cells 402 of the grid 400, such as via the input device 122, to view various features therein. The control unit 116 also shows various obstacles 404 within and outside the grid 400 on the display 120. Further, the control unit 116 also shows highlighted areas 406 (such as in different colors, flashing lighted areas, and/or the like) which indicate locations where inconsistencies in the different datasets are detected.

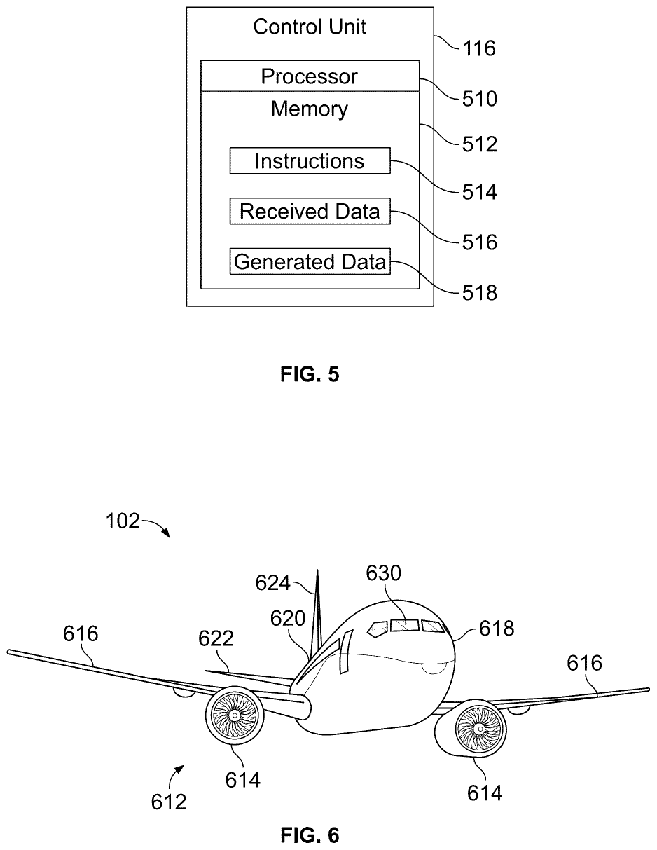

FIG. 5 illustrates a schematic block diagram of the control unit 116, according to an example of the present disclosure. In at least one example, the control unit 116 includes at least one processor 510 in communication with a memory 512. The memory 512 stores instructions 514, received data 516, and generated data 518. The control unit 116 shown in FIG. 5 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 116 may be or include one or more processors that are configured to control operation, as described herein.

The control unit 116 is configured to execute a set of instructions that are stored in one or more data storage units or elements (such as one or more memories), in order to process data. For example, the control unit 116 may include or be coupled to one or more memories. The data storage units may also store data or other information as desired or needed. The data storage units may be in the form of an information source or a physical memory element within a processing machine.

The set of instructions may include various commands that instruct the control unit 116 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 116. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 116 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

In at least one example, the control unit 116 can further control, at least in part, the controls 112 of the aircraft 102 to operate the aircraft 102 based on the locations of the obstacles 110, such as determined from information within the different datasets (such as the data in the first format 126 and the data in the second format 128). For example, based on locations of the obstacles 110, the control unit 116 can automatically operate the controls 112 to increase or decrease ground or airspeed, rate of climb, and the like of the aircraft 102 in order to navigate the aircraft 102 in relation to the obstacles 110. The control unit 116 can be in communication with the tracking sub-system 114, and receive tracking signals therefrom. Based on the tracking signals indicative of a current, real time tracked position of the aircraft 102, and the obstacle information received from the datasets regarding the positions of the obstacles 110 in relation to at least portions of the flight path 108 (such as during takeoff and landing phases), the control unit 116 can automatically operate the controls 112 to automatically navigate the aircraft 102 in relation to the obstacles 110.

As another example, the control unit 116 can be used to prevent operation of certain aircraft, such as drones or unmanned aerial vehicles (UAV), in relation to certain obstacles 110. The control unit 116 can establish one or more geofences in relation to certain determined obstacles 110, which can prevent operation of the drones.

As another example, the control unit 116 can be used to generate maps based on the determined obstacles 110. The control unit 116 can determine accurate locations of the obstacles 110 based as described herein, and use such information to produce accurate maps.

In at least one example, all or part of the systems and methods described herein may be or otherwise include an artificial intelligence (AI) or machine-learning system that can automatically perform the operations of the methods also described herein. For example, the control unit 116 can be an artificial intelligence or machine learning system. These types of systems may be trained from outside information and/or self-trained to repeatedly improve the accuracy with how data is analyzed to determine locations of obstacles 110 from information within the datasets (for example, the data in the first format 126 and the data in the second format 128), similarities and/or inconsistencies within the datasets, grids, and/or the like, as described herein. Over time, these systems can improve by determining such information with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of obstacles, inconsistencies in data, quality checks of the data, and the like. The training minimizes conflicts and interference by performing an iterative training algorithm, in which the systems are retrained with an updated set of data (for example, data received during and/or after each flight of the aircraft 102) and based on the feedback examined prior to the most recent training of the systems. This provides a robust analysis model that can better determine the most cost effective and efficient flight paths for the aircraft 102.

In at least one example, the control unit 116 includes or represents an artificial neural network (ANN) that identifies patterns in the visual representations of data, classifies the patterns (for example, assigns a class to an identified pattern, such as class #1, class #2, and so on) based on the contents of the patterns that are identified, and identifies one or more flight paths, obstacles, and the like (as described herein) based on the classifications. Usage of a specially trained ANN to identify such information in this way provides improvements over traditional manual methods, including more accurate identification of efficient flight paths, locations of obstacles, inconsistencies in datasets, and identification various types of flight paths on a much larger scale than is possible with humans determining flight paths, and identification of such information much faster and/or at a much more rapid frequency than is possible with humans. The ANN can be realized through software, hardware, or a combination of software and hardware. The structure of the ANN can be a series of layers, with each layer including one or more artificial neurons arranged in one or more neuron arrays. Each of these neurons may include or represent a register, a microprocessor, and at least one input. Each neuron can produce an output, or activation, based on an activation function that uses the outputs of the previous layer and a set of weights as inputs. Each neuron in a neuron array can be connected to another neuron in the same layer or in another layer via one or more synaptic circuits. A synaptic circuit may include a memory for storing a synaptic weight. One example of this ANN may be a deep neural network having an input layer, an output layer, and a plurality of fully connected hidden layers. In some examples, the ANN (e.g., the control unit 116) can be implemented by an application-specific integrated circuit (ASIC) specially customized for the specific artificial intelligence application described herein and provide superior computing capabilities and reduced electricity consumption compared to traditional computers.

Training data can be generated by receiving continuous data at the control unit 116 and using the control unit 116 to discretize the continuous data. Optionally, the control unit 116 can be trained with a pretrained model. The training data or pretrained model may be received by the control unit 116 remotely over one or more networks. The training data may be historical data, which the neural network can use to learn patterns in the visual representations of the data to identify or detect the same (or similar) patterns in other data collected from other parts or equipment. The trained ANN monitors additional visual representations of data to identify patterns and classify the patterns. If the trained ANN detects one or more patterns, the trained ANN can classify the pattern(s) to generate classification data which can be output to a user and/or used to re-train the ANN. For example, the classification data may identify the type or mode of a potential or upcoming failure of the part or equipment.

The ANN of the control unit 116 can continue to learn to improve identification of patterns in data visualizations, as well as improve the classification of the identified patterns. This continued learning can occur by, for example, changing the output generated by one or more of the neurons responsive to receiving the same input (e.g., a neuron produces a different output after the change), changing the activation function of one or more neurons, changing one or more of the weights, and/or changing one or more of the connections between the neurons (or which neurons are connected with each other). Changing one or more of these factors can cause the ANN to produce a different output (e.g., a different pattern is identified and/or a different classification is selected) than prior to the change.

Examples of the subject disclosure provide systems and methods that allow large amounts of data to be quickly and efficiently analyzed by a computing device. For example, the control unit 116 can analyze various aspects of flights of the aircraft 102 based on the datasets from the ANSP 124. Further, the control unit 116 determines locations of obstacles within the datasets, and any inconsistencies between the datasets, which can be in formats not readily discernable by a human being. As such, large amounts of data, which may not be discernable by human beings, are being tracked and analyzed. The vast amounts of data are efficiently organized and/or analyzed by the control unit 116, as described herein. The control unit 116 analyzes the data in a relatively short time in order to quickly and efficiently determine locations of the obstacles, inconsistencies in datasets, and the like. A human being would be incapable of efficiently analyzing such vast amounts of data in such a short time. As such, examples of the subject disclosure provide increased and efficient functionality, and vastly superior performance in relation to a human being analyzing the vast amounts of data.

Components of the system 100, such as the control unit 116, provide and/or enable a computer system to operate as a special computer system for determining locations of obstacles 110, inconsistencies in datasets, grids, and the like. The control unit 116 improves upon computing devices by allowing for automatic detection of obstacles within datasets, and a quality check of different datasets, which substantially reduces computing time and power.

FIG. 6 illustrates a perspective front view of the aircraft 102, according to an example of the present disclosure. The aircraft 102 includes a propulsion system 612 that includes engines 614, for example. Optionally, the propulsion system 612 may include more engines 614 than shown. The engines 614 are carried by wings 616 of the aircraft 102. In other examples, the engines 614 may be carried by a fuselage 618 and/or an empennage 620. The empennage 620 may also support horizontal stabilizers 622 and a vertical stabilizer 624. The fuselage 618 of the aircraft 102 defines an internal cabin 630, which includes a flight deck or cockpit, one or more work sections (for example, galleys, personnel carry-on baggage areas, and the like), one or more passenger sections (for example, first class, business class, and coach sections), one or more lavatories, and/or the like. FIG. 6 shows an example of an aircraft 102. It is to be understood that the aircraft 102 can be sized, shaped, and configured differently than shown in FIG. 6.

Further, the disclosure comprises examples according to the following clauses:

Clause 1. A system comprising:

A control unit configured to:
receive a first dataset and a second dataset, wherein the first dataset includes first data in a first format, wherein the second dataset includes second data in a second format, and wherein each of the first dataset and the second dataset includes information regarding obstacles, and
compare the first dataset with the second dataset to determine a quality check of the information within the first dataset and the second dataset.

Clause 2. The system of Clause 1, wherein one or both of the control unit or the user interface are remote from an aircraft.

Clause 3. The system of Clause 1, wherein an aircraft comprises one or both of the control unit or the user interface.

Clause 4. The system of any of Clauses 1-3, wherein the control unit is configured to receive the first dataset and the second dataset from one or more air navigation service providers.

Clause 5. The system of any of Clauses 1-4, wherein the control unit is further configured to geospatially index the first data and the second data.

Clause 6. The system of any of Clauses 1-5, wherein the control unit is further configured to determine boundaries within the first data and the second data from classifications set forth by the International Civil Aviation Organization (ICAO).

Clause 7. The system of Clause 6, wherein the control unit is further configured to determine ICAO Area 1, ICAO Area 2, ICAO Area 2a, ICAO Area 2b, ICAO Area 2c, ICAO Area 2d, and ICAO Area 3, ICAO Area 4 within the first data and the second data.

Clause 8. The system of Clause 7, wherein the control unit is further configured to determine one or more combined areas including two or more of ICAO Area 1, ICAO Area 2, ICAO Area 2a, ICAO Area 2b, ICAO Area 2c, ICAO Area 2d, and ICAO Area 3, ICAO Area 4.

Clause 9. The system of any of Clauses 1-8, wherein the control unit is further configured to generate a dynamic grid.

Clause 10. The system of any of Clauses 1-9, wherein the control unit is configured to determine the quality check based on comparing elevation, latitude, longitude, obstacle type, and source identifier for the obstacles within the first dataset and the second dataset.

Clause 11. The system of any of Clauses 1-10, wherein the control unit is further configured to check that each of the first dataset and the second dataset are in correct formats for a particular country.

Clause 12. The system of any of Clauses 1-11, further comprising:
an aircraft configured to travel between a departure airport and an arrival airport according to a flight path; and
a user interface, wherein the control unit is further configured to output one or more signals regarding the obstacles and the quality check, and wherein the user interface is configured to receive the one or more signals regarding the obstacles and the quality check,
wherein the aircraft is configured to be operated in relation to the obstacles.

Clause 13.A method comprising:
receiving, by a control unit, a first dataset and a second dataset, wherein the first dataset includes first data in a first format, wherein the second dataset includes second data in a second format, and wherein each of the first dataset and the second dataset includes information regarding obstacles;
comparing, by the control unit, the first dataset with the second dataset; and
determining, by the control unit via said comparing, a quality check of the information within the first dataset and the second dataset.

Clause 14. The method of Clause 13, further comprising geospatially indexing, by the control unit, the first data and the second data.

Clause 15. The method of Clauses 13 or 14, further comprising determine, by the control unit, boundaries within the first data and the second data from classifications set forth by the International Civil Aviation Organization (ICAO).

Clause 16. The method of any of Clauses 13-15, further comprising generating, by the control unit, a dynamic grid.

Clause 17. The method of any of Clauses 13-16, wherein said comparing comprises comparing elevation, latitude, longitude, obstacle type, and source identifier for the obstacles within the first dataset and the second dataset.

Clause 18. The method of any of Clauses 13-17, further comprising checking, by the control unit, that each of the first dataset and the second dataset are in correct formats for a particular country.

Clause 19. The method of any of Clauses 13-18, further comprising outputting one or more signals to a user interface regarding the obstacles and the quality check.

Clause 20. A system comprising:
an aircraft configured to travel between a departure airport and an arrival airport;
a user interface; and
a control unit in communication with the user interface, wherein the control unit is configured to:
   receive a first dataset and a second dataset, wherein the first dataset includes first data in a first format, wherein the second dataset includes second data in a second format, and wherein each of the first dataset and the second dataset includes information regarding obstacles,
   check that each of the first dataset and the second dataset are in correct formats for a particular country,
   determine International Civil Aviation Organization (ICAO) Area 1, ICAO Area 2, ICAO Area 2a, ICAO Area 2b, ICAO Area 2c, ICAO Area 2d, and ICAO Area 3, ICAO Area 4 within the first data and the second data,
   determine one or more combined areas including two or more of ICAO Area 1, ICAO Area 2, ICAO Area 2a, ICAO Area 2b, ICAO Area 2c, ICAO Area 2d, and ICAO Area 3, ICAO Area 4,
   geospatially index the first data and the second data,
   generate a dynamic grid in relation to the flight path,
   compare the first dataset with the second dataset to determine a quality check of the information within the first dataset and the second dataset, and
   output one or more signals to the user interface regarding the obstacles and the quality check,
wherein the aircraft is configured to be operated in relation to the obstacles.

As described herein, examples of the present disclosure provide a system and a method for determining a quality check between obstacle data in different formats.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to:
receive a first dataset and a second dataset, wherein the first dataset includes first data in a first format, wherein the second dataset includes second data in a second format, and wherein each of the first dataset and the second dataset includes information regarding obstacles, and
compare the first dataset with the second dataset to determine a quality check of the information within the first dataset and the second dataset.

2. The system of claim 1, wherein one or both of the control unit or the user interface are remote from an aircraft.

3. The system of claim 1, wherein an aircraft comprises one or both of the control unit or the user interface.

4. The system of claim 1, wherein the control unit is configured to receive the first dataset and the second dataset from one or more air navigation service providers.

5. The system of claim 1, wherein the control unit is further configured to geospatially index the first data and the second data.

6. The system of claim 1, wherein the control unit is further configured to determine boundaries within the first data and the second data from classifications set forth by the International Civil Aviation Organization (ICAO).

7. The system of claim 6, wherein the control unit is further configured to determine ICAO Area 1, ICAO Area 2, ICAO Area 2a, ICAO Area 2b, ICAO Area 2c, ICAO Area 2d, and ICAO Area 3, ICAO Area 4 within the first data and the second data.

8. The system of claim 7, wherein the control unit is further configured to determine one or more combined areas including two or more of ICAO Area 1, ICAO Area 2, ICAO Area 2a, ICAO Area 2b, ICAO Area 2c, ICAO Area 2d, and ICAO Area 3, ICAO Area 4.

9. The system of claim 1, wherein the control unit is further configured to generate a dynamic grid.

10. The system of claim 1, wherein the control unit is configured to determine the quality check based on comparing elevation, latitude, longitude, obstacle type, and source identifier for the obstacles within the first dataset and the second dataset.

11. The system of claim 1, wherein the control unit is further configured to check that each of the first dataset and the second dataset are in correct formats for a particular country.

12. The system of claim 1, further comprising:
an aircraft configured to travel between a departure airport and an arrival airport according to a flight path; and
a user interface, wherein the control unit is further configured to output one or more signals regarding the obstacles and the quality check, and wherein the user interface is configured to receive the one or more signals regarding the obstacles and the quality check,
wherein the aircraft is configured to be operated in relation to the obstacles.

13. A method comprising:
receiving, by a control unit, a first dataset and a second dataset, wherein the first dataset includes first data in a first format, wherein the second dataset includes second data in a second format, and wherein each of the first dataset and the second dataset includes information regarding obstacles;
comparing, by the control unit, the first dataset with the second dataset; and
determining, by the control unit via said comparing, a quality check of the information within the first dataset and the second dataset.

14. The method of claim 13, further comprising geospatially indexing, by the control unit, the first data and the second data.

15. The method of claim 13, further comprising determine, by the control unit, boundaries within the first data and the second data from classifications set forth by the International Civil Aviation Organization (ICAO).

16. The method of claim 13, further comprising generating, by the control unit, a dynamic grid.

17. The method of claim 13, wherein said comparing comprises comparing elevation, latitude, longitude, obstacle type, and source identifier for the obstacles within the first dataset and the second dataset.

18. The method of claim 13, further comprising checking, by the control unit, that each of the first dataset and the second dataset are in correct formats for a particular country.

19. The method of claim 13, further comprising outputting one or more signals to a user interface regarding the obstacles and the quality check.

20. A system comprising:
an aircraft configured to travel between a departure airport and an arrival airport;
a user interface; and
a control unit in communication with the user interface, wherein the control unit is configured to:
receive a first dataset and a second dataset, wherein the first dataset includes first data in a first format, wherein the second dataset includes second data in a second format, and wherein each of the first dataset and the second dataset includes information regarding obstacles,
check that each of the first dataset and the second dataset are in correct formats for a particular country,
determine International Civil Aviation Organization (ICAO) Area 1, ICAO Area 2, ICAO Area 2a, ICAO Area 2b, ICAO Area 2c, ICAO Area 2d, and ICAO Area 3, ICAO Area 4 within the first data and the second data,
determine one or more combined areas including two or more of ICAO Area 1, ICAO Area 2, ICAO Area 2a, ICAO Area 2b, ICAO Area 2c, ICAO Area 2d, and ICAO Area 3, ICAO Area 4,
geospatially index the first data and the second data,
generate a dynamic grid in relation to the flight path,
compare the first dataset with the second dataset to determine a quality check of the information within the first dataset and the second dataset, and
output one or more signals to the user interface regarding the obstacles and the quality check,
wherein the aircraft is configured to be operated in relation to the obstacles.
